(19) United States
(12) Patent Application Publication
(10) Pub. No.: US 2011/0007051 A1
(43) Pub. Date: Jan. 13, 2011

(54) DRIVER FOR PLASMA DISPLAY PANEL

(75) Inventors: Jae Han YOON, Suwon (KR); Dong Kyun Ryu, Seoul (KR); Won Chan Choi, Seongnam (KR); Peel Sik Jeon, Hwaseong (KR); Sung Mok Kim, Suwon (KR); Bum Sik Wang, Suwon (KR); Kwang Hun Song, Suwon (KR); Kyung Hyun Kim, Seoul (KR); Jae Gen Eom, Hwaseong (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/646,676

(22) Filed: Dec. 23, 2009

(30) Foreign Application Priority Data
Jul. 10, 2009 (KR) 10-2009-0062944

(51) Int. Cl. G06F 3/038

(52) U.S. Cl. 345/211

(57) ABSTRACT

Disposed is a driver for a plasma display panel, which is capable of absorbing surplus power of a plasma display panel by power conversion switching performed according to the switching of a sustain circuit to form a transmission path using resonance between the inductance of a transformer for power conversion and the capacitance of the plasma display panel, without using an energy recovery circuit. The driver includes a power supply unit including preset inductance, and converting alternating current (AC) commercial power into preset driving power by using the inductance, a driving unit switching the driving power from the power supply unit according to a logic signal and supplying the switched driving power to a plasma display panel. Surplus power of the driving unit is transmitted to the power supply unit by resonance between the inductance of the power supply unit and capacitance of the plasma display panel.

### CROSS-REFERENCE TO RELATED APPLICATIONS

This application claims the priority of Korean Patent Application No. 10-2009-0062944 filed on Jul. 10, 2009, in the Korean Intellectual Property Office, the disclosure of which is incorporated herein by reference.

### BACKGROUND OF THE INVENTION

1. Field of the Invention

The present invention relates to a driver for a plasma display panel, and more particularly, to a driver for a plasma display panel, which is capable of absorbing surplus power of a plasma display panel by performing power conversion switching according to the switching of a sustain circuit and thus forming a transmission path using resonance between the inductance of a transformer for power conversion and the capacitance of the plasma display panel, without using an energy recovery circuit.

2. Description of the Related Art

Recently, various kinds of display devices have been developed and used. Representative examples of display devices include a cathode-ray tube (CRT), a liquid crystal display (LCD) and a plasma display panel (PDP).

In particular, LCDs and PDPs are being increasingly used since they are slim and easy to adapt for wide screens.

Unlike a PDP, an LCD does not illuminate by itself and therefore employs a backlight. A commonly used backlight for the LCD is a cold cathode fluorescent lamp (CCFL), which has limitations such as a large size, large power consumption and high manufacturing costs.

Therefore, a PDP is mainly used as a display device in order to meet the requirements for light and slim characteristics and cost reductions, and as well as consumer demand. However, this PDP is also required to be slimmer, lighter and more cost-effective.

### SUMMARY OF THE INVENTION

An aspect of the present invention provides a driver for a plasma display panel (PDP), which is capable of absorbing surplus power of a plasma display panel by performing power conversion switching according to the switching of a sustain circuit and thus forming a transmission path using resonance between the inductance of a transformer for power conversion and the capacitance of the plasma display panel, without using an energy recovery circuit.

According to an aspect of the present invention, there is provided a driver for a plasma display panel, the driver including: a power supply unit including preset inductance, and converting alternating current (AC) commercial power into preset driving power by using the inductance; and a driving unit switching the driving power from the power supply unit according to a logic signal and supplying the switched driving power to a plasma display panel, wherein surplus power of the driving unit is transmitted to the power supply unit by resonance between the inductance of the power supply unit and capacitance of the plasma display panel.

The power supply unit may include a power conversion part receiving and switching power to convert the power into the driving power.

The driving unit may include a sustain part switching the driving power according to the logic signal and charging/discharging the plasma display panel.

The power conversion part may perform switching according to the switching of the driving unit.

The power conversion part may include: a switching circuit performing power conversion by switching the received power according to the switching of the driving unit; and a transformer including a primary winding receiving power from the switching circuit and a secondary winding forming a turns ratio with the primary winding.

The sustain part may include: a pair of Y electrode switches including a first Y electrode switch and a second Y electrode switch connected in series to each other; and a pair of X electrode switches connected in parallel to the pair of Y electrode switches and including a first X electrode switch and a second X electrode switch connected in series to each other. The first Y electrode switch may be switched ON and OFF in association with the second X electrode switch, the second Y electrode switch may be switched ON and OFF in association with the first X electrode switch, alternately with the switching of the first Y electrode switch and the second X electrode switch, and a connection point between the first and second Y electrode switches may be connected to one end of the plasma display panel, and a connection point between the first and second X electrode switches may be connected to the other end of the plasma display panel.

The switching circuit may include first and second switches connected in series to each other between two input terminals of the received power. The first switch may be switched ON when the second Y electrode switch and the first X electrode switch are switched ON, the first Y electrode switch may be switched ON alternately with the first switch, and a connection node between the first and second switches may be electrically connected to the primary winding of the transformer.

When a voltage of the plasma display panel rises, a body diode of the second switch may be turned ON in a dead time, which is a switching-off period of the first and second Y electrode switches and the first and second X electrode switches, and form a transmission path for the surplus power being transmitted from the driving unit to the power conversion part. When the voltage of the plasma display panel falls, a body diode of the first switch may be turned ON in a dead time, which is a switching-off period of the first and second Y electrode switches and the first and second X electrode switches, and form a transmission path for the surplus power being transmitted from the driving unit to the power conversion part. Inductance of the power supply unit may resonate with capacitance of the plasma display panel when the transmission path is formed.

The first and second Y electrode switches and the first and second X electrode switches may be switched OFF, and the first switch may be switched ON and then switched OFF to turn ON the body diode of the second switch in a voltage rising period of the plasma display panel. The first and second Y electrode switches and the first and second X electrode switches may be switched OFF, and the second switch may be switched ON and then switched OFF to turn ON the body diode of the first switch in a voltage falling period of the plasma display panel.

The first Y electrode switch and the second X electrode switch may be switched ON, the second Y electrode switch and the first X electrode switch may be switched OFF and the second switch may be switched ON in a maximum-voltage sustain period of the plasma display panel between the voltage rising period and the voltage falling period of the plasma display panel. The second Y electrode switch and the first X electrode switch may be switched ON, the first Y electrode switch and the second X electrode switch may be switched OFF and the first switch may be switched ON in a minimum-voltage sustain period of the plasma display panel between the voltage falling period and the voltage rising period of the plasma display panel.

The power supply unit may include: a rectifying/smoothing part rectifying and smoothing the AC commercial power; and a power factor correction part correcting a power factor of the rectified and smoothed power and supplying DC power to the power conversion part.

The inductance may be leakage inductance of the transformer, inductance of an inductor device electrically connected in series between the primary winding and the transformer, or combined inductance of the leakage inductance of the transformer and the inductance of the inductor device.

According to another aspect of the present invention, there is provided a driver for a plasma display panel, the driver including: a power supply unit switching alternating current (AC) commercial power and converting switched power into preset driving power; and a driving unit switching the driving power from the power supply unit according to a logic signal and supplying the switched driving voltage to a plasma display panel, wherein switching of the power supply unit is performed according to switching of the driving unit to thereby form a transmission path through which surplus power of the driving unit is transmitted to the power supply unit, so that the surplus power is transmitted to the power supply unit.

A body diode of the first switch or a body diode of the second switch is turned ON in a dead time, which is a switching-off period of first and second Y electrode switches and first and second X electrode switches.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram schematically illustrating the configuration of a driver for a plasma display panel according to an exemplary embodiment of the present invention;

FIGS. 2A through 2I are diagrams illustrating current flow paths in operational modes for the driver for a plasma display panel depicted in FIG. 1; and

FIG. 3 illustrates signal waveform graphs of the main parts of the driver for a plasma display panel of present invention, in each of the operational modes depicted in FIGS. 2A through 2I.

### DETAILED DESCRIPTION OF THE PREFERRED EMBODIMENT

Exemplary embodiments of the present invention will now be described in detail with reference to the accompanying drawings.

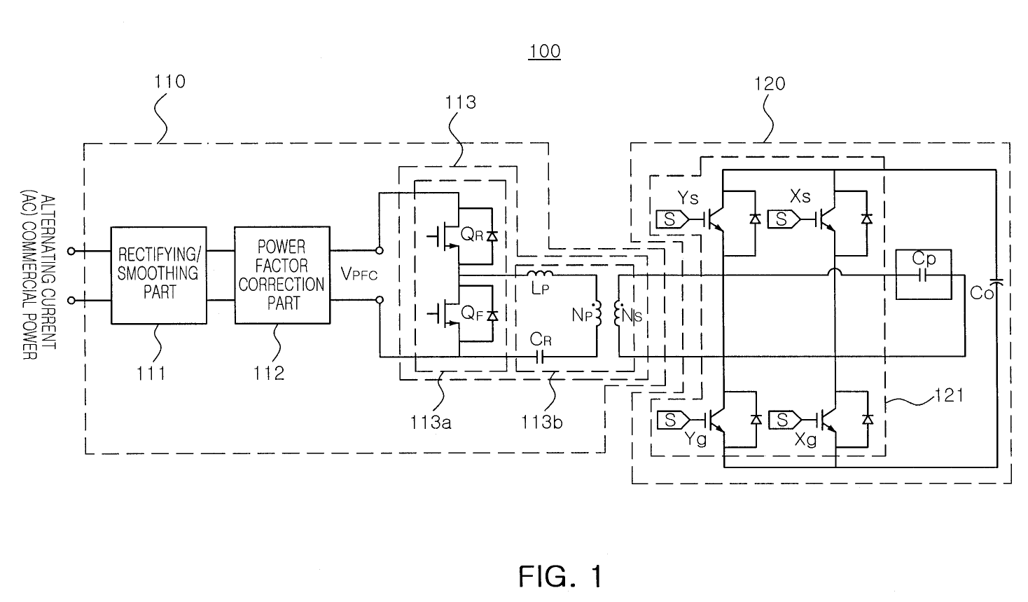

FIG. 1 is a block diagram schematically illustrating the configuration of a driver for a plasma display panel (PDP) according to an exemplary embodiment of the present invention.

Referring to FIG. 1, a driver 100 for a plasma display panel, according to an exemplary embodiment of the present invention, may include a power supply unit 110 and a driving unit 120.

The power supply unit 110 converts alternating current (AC) commercial power into driving power having a preset voltage level, and supplies the driving power to the driving unit 120. To this end, the power supply unit 110 may include a power conversion part 113 switching and converting power. In addition, the power supply unit 110 may further include a rectifying/smoothing part 111 rectifying and smoothing the AC commercial power, and a power factor correction part 112 correcting the power factor of the rectified and smoothed power to supply DC power to the power conversion part 113.

The power conversion part 113 may include a switching circuit 113a switching DC power VPFC, and a transformer 113b converting the voltage level of the switched power from the switching circuit 113a.

The switching circuit 113a may include first and second switches Q_{R} and Q_{F} of a half bridge type, which are connected in series to each other between input terminals for the DC power from the power factor correction part 112. The first and second switches Q_{R} and Q_{F} may each include a body diode.

The transformer 113b includes a primary winding Np and a secondary winding Ns having a preset turns ratio therebetween. The primary winding Np may be connected in parallel to the second switch Q_{F} of the switching circuit 113a. Leakage inductance Lp and capacitance C_{R} may be formed separately between the primary coil Np and the second switch Q_{F}. The leakage inductance Lp may be the leakage inductance of the transformer 113b itself, or leakage inductance caused by an inductor device that is additionally connected.

The driving unit 120 may include a sustain part 121 switching driving power from the power supply unit 110 and supplying switched power to a plasma display panel forming capacitance Cp. The driving unit 120 may further include a stabilizing capacitor Co for stabilizing power supplied from the sustain part 121.

The sustain part 121 may include a pair of Y electrode switches Ys and Yg and a pair of X electrode switches Xs and Xg switched according to a logic signal S from the outside. The pair of Y electrode switches Ys and Yg may be connected in parallel with the pair of X electrode switches Xs and Xg. The stabilizing capacitor Co may be connected in parallel to the pair of Y electrode switches Ys and Yg and the pair of X electrode switches Xs and Xg.

The pair of Y electrode switches Ys and Yg may include a first Y electrode switch Ys and a second Y electrode switch Yg that are connected in series to each other. The pair of X electrode switches Xs and Xg may include a first X electrode switch Xs and a second X electrode switch Xg that are connected in series to each other.

A connection point between the first Y electrode switch Ys and the second Y electrode switch Yg may be connected to a

Y electrode of the plasma display panel forming capacitance Cp. Also, a connection point between the first X electrode switch Xs and the second X electrode switch Xg may be connected to an X electrode of the plasma display panel.

The switching of the first and second switches Q_{R} and Q_{F} is performed according to the switching of the first and second Y electrode switches Ys and Yg and the first and second X electrode switches Xs and Xg of the sustain part 121, thereby forming an LC resonance path between the leakage inductance Lp of the transformer 113b and the capacitance Cp of the plasma display panel. Thus, the surplus power of the driver 120 is transferred to the power conversion part 113. In this away, the function of an existing energy recovery circuit (ERC) can be substituted.

Hereinafter, the operation and effects of the present invention will be described with reference to accompanying drawings.

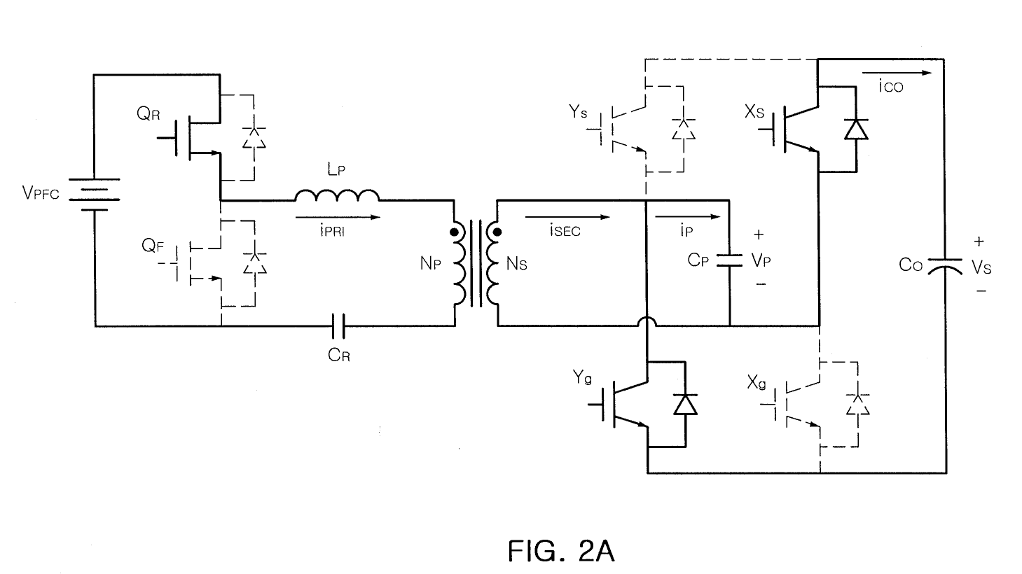

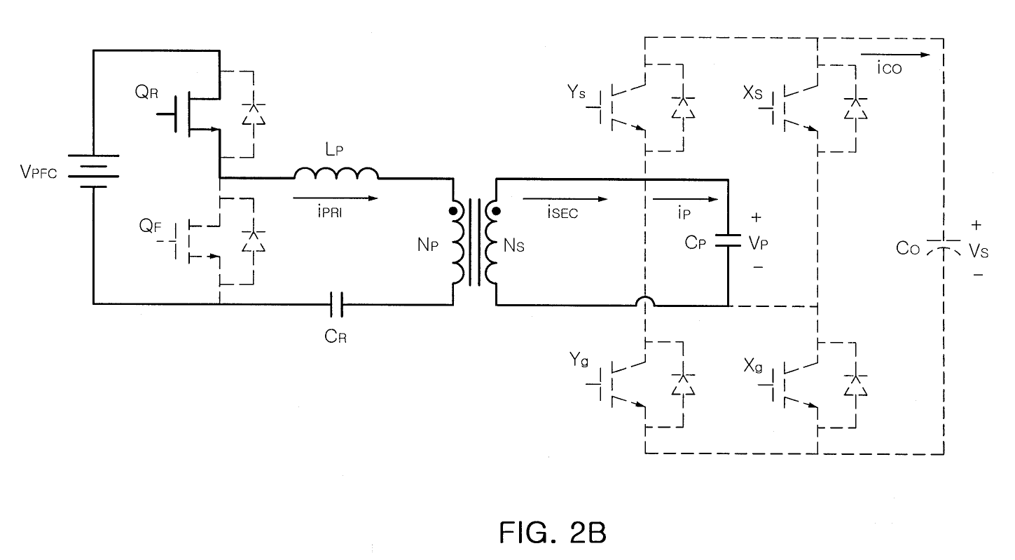

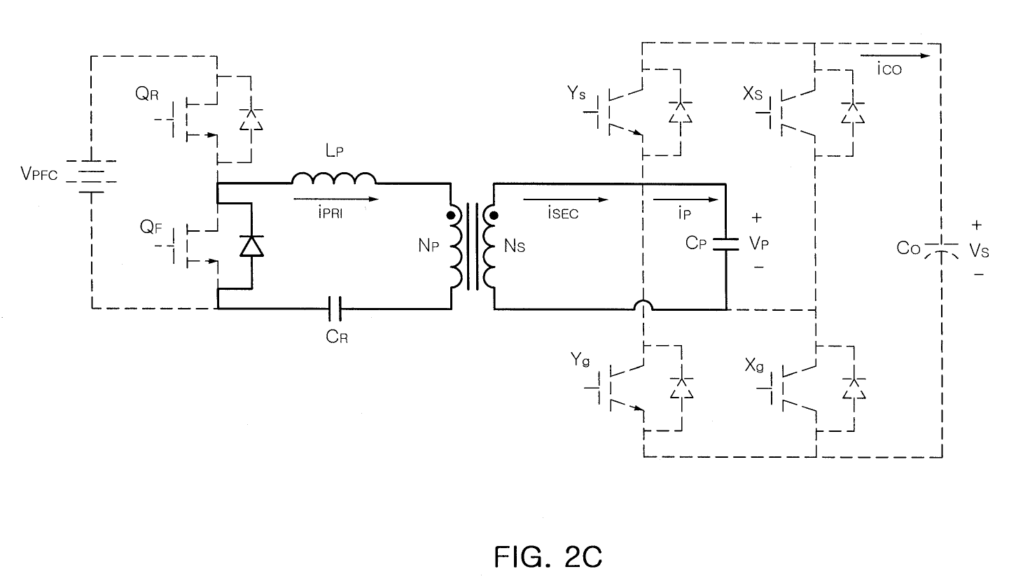

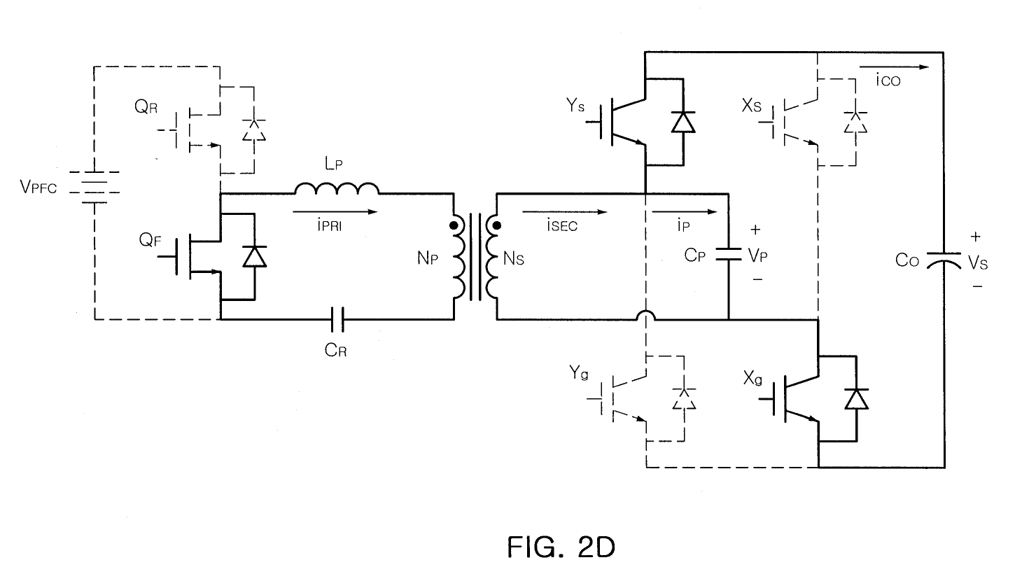

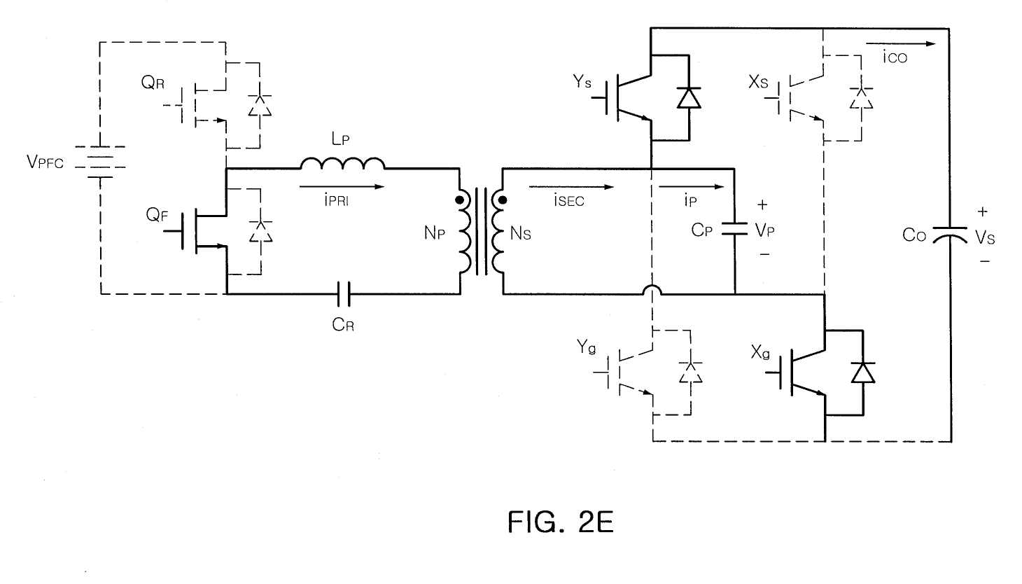

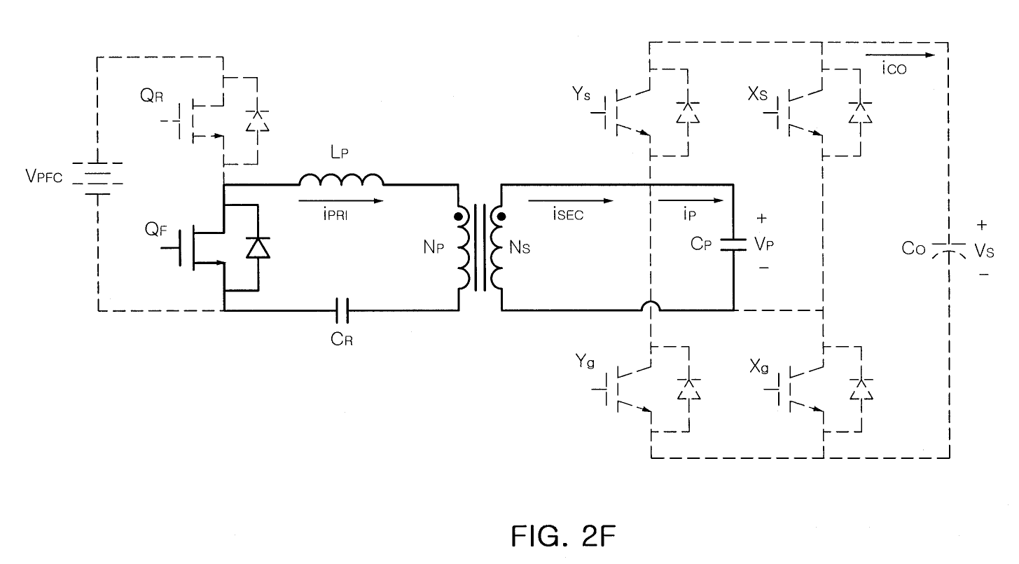

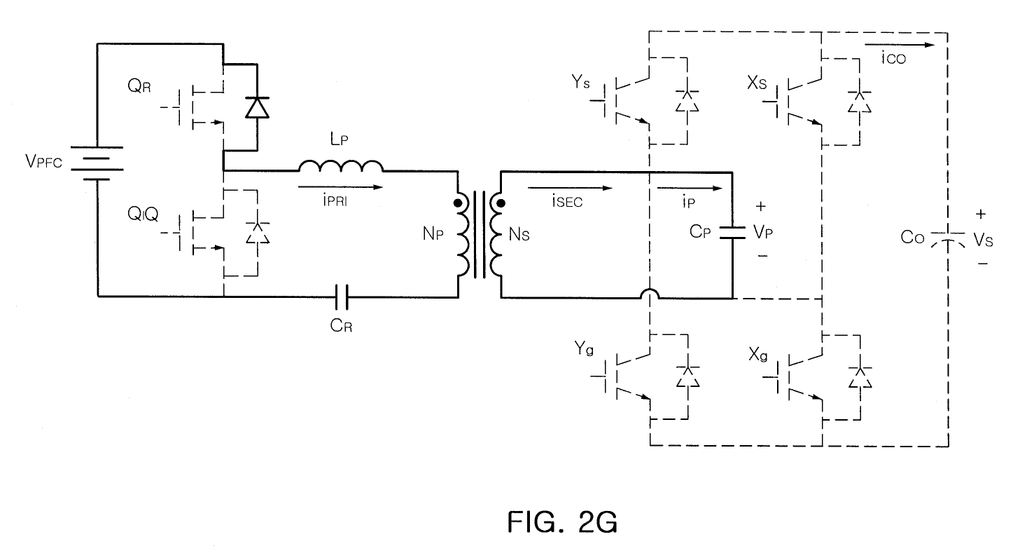

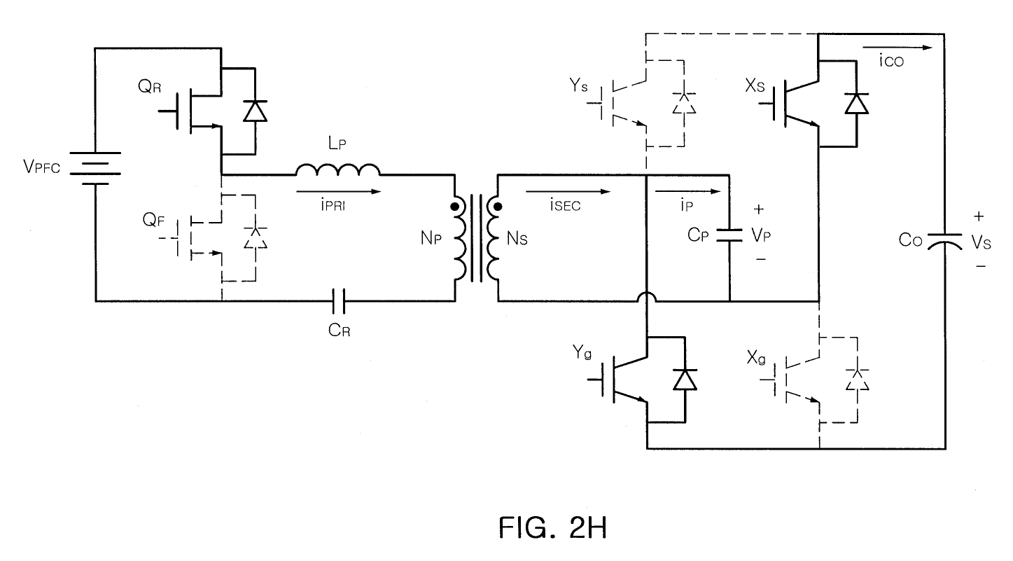

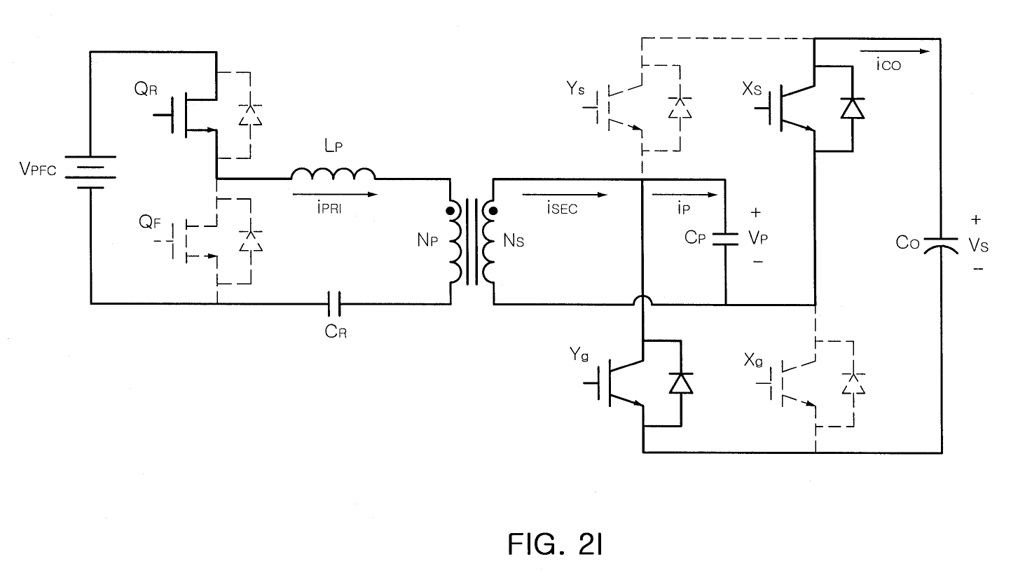

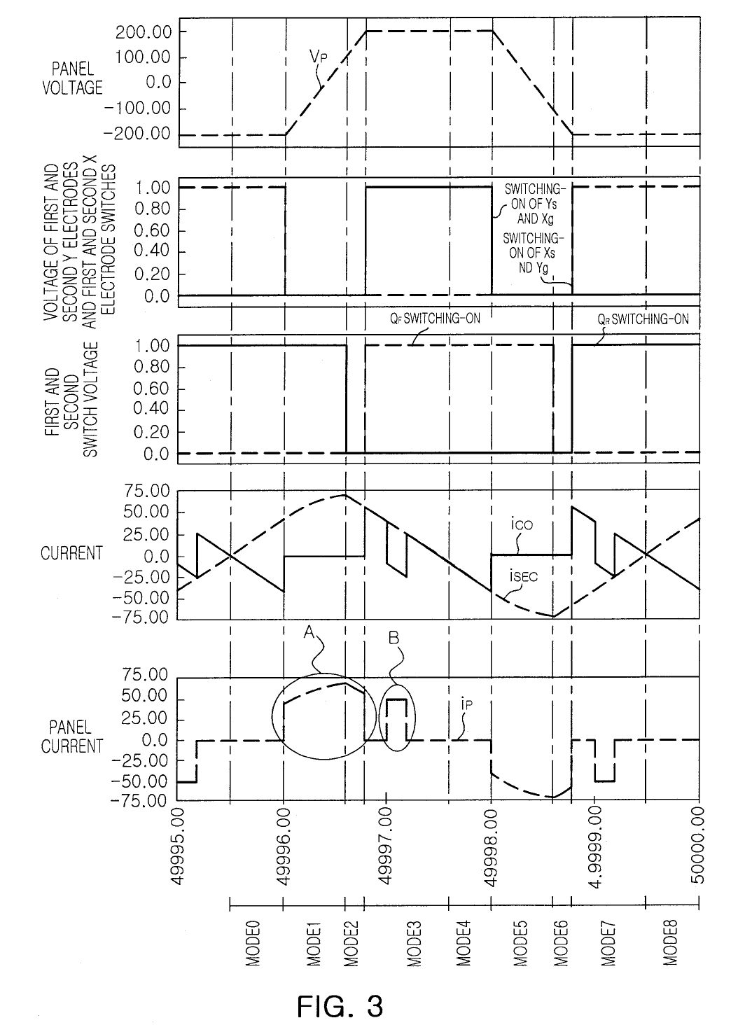

FIGS. 2A through 2I are diagrams showing current flow paths in operational modes for the driver for a plasma display panel depicted in FIG. 1. FIG. 3 illustrates signal waveform graphs of the main parts of the driver for a plasma display panel according to an exemplary embodiment of the present invention, in each of the operational modes shown in FIGS. 2A through 2I.

In FIGS. 2A through 2I, respective current flow paths are expressed by solid lines. First, referring to both FIGS. 2A and 3, the first switch Q_{R}, the second Y electrode switch Yg and the first X electrode switch Xs are switched ON in order to supply power to the plasma display panel forming capacitance Cp. Accordingly, a voltage of (½)V_{PFC}+(Np/Ns)Vs is applied to the leakage inductance Lp to thereby linearly increase the primary-side current I_{PRI} of the transformer 113b. Here, the voltage Vs of the stabilizing capacitor Co is discharged to cause the current ico to flow in a reverse direction (Mode 0 in FIG. 3).

Thereafter, referring to FIGS. 2B and 3, the second Y electrode switch Yg and the first X electrode switch Xs are switched OFF while the first switch Q_{R} is switched ON. Accordingly, a resonance path is formed to cause LC resonance between the leakage inductance Lp and the capacitance Cp of the plasma display panel, and therefore, the voltage Vp charged in the plasma display panel rises. Since the current ico is zero, the voltage Vs is maintained at the previous level of Mode 0 (Mode 1 of FIG. 3). ‘A’ in FIG. 3 indicates a displacement current at this time.

Referring to FIGS. 2C and 3, the first switch Q_{R}, the second Y electrode switch Yg and the first X electrode switch Xs are switched OFF, and the body diode of the second switch Q_{F} is turned ON. At this time, the LC resonance between the leakage inductance Lp and the capacitance Cp of the plasma display panel is continued, and therefore the voltage charged in the plasma display panel rises continuously. Since the current ico is zero, the voltage Vs is maintained at the previous level of Mode 1 (Mode 2 in FIG. 3).

Referring to FIGS. 2D and 3, when the level of the voltage Vp charged in the plasma display panel becomes equal to the level of the voltage Vs charged in the stabilizing capacitor Co, the first Y electrode switch Ys and the second X electrode switch Xg are switched ON to thereby maintain the level of the voltage Vp charged in the plasma display panel at the level of the voltage Vx charged in the stabilizing capacitor Co. At this time, a voltage of −(½)V_{PFC}−(Np/Ns)Vs is applied to the leakage inductance Lp to thereby linearly decrease the primary-side current I_{PRI} of the transformer 113b. Since the current ico flows in a forward direction, the voltage Vs of the stabilizing capacitor Co is charged and the surplus level of the voltage Vp charged in the plasma display panel is discharged. To discharge the voltage Vp charged in the plasma display panel, the second switch Q_{F} is switched ON (Mode 3 of FIG. 3). Here, ‘B’ in FIG. 3 indicates a discharge current at this time.

Referring to FIGS. 2E and 3, the second switch Q_{F}, the first Y electrode switch Ys and the second X electrode switch Xg are switched ON, and a voltage of −(½)V_{PFC}−(Np/Ns)Vs is applied to the leakage inductance Lp to thereby linearly decrease the primary-side current I_{PRI} of the transformer 113b. Since the current ico flows in a reverse direction, the voltage Vs of the stabilizing capacitor Co is discharged (Mode 4 of FIG. 3).

Referring to FIGS. 2F and 3, the second switch Q_{F} is switched ON, and the first Y electrode switch Ys and the second X electrode switch Xg are switched OFF. Thus, a resonance path is formed to cause LC resonance between the leakage inductance Lp and the capacitance Cp of the plasma display panel, and therefore, the voltage Vp charged in the plasma display panel falls. At this time, since the current ico is zero, the voltage Vs of the stabilizing capacitor Co is maintained at the previous level of Mode 4 (Mode 5 in FIG. 3).

Referring to FIGS. 2G and 3, the second switch Q_{F}, the first Y electrode switch Ys and the second X electrode switch Xg are switched OFF, and the body diode of the second switch Q_{R} is turned ON. At this time, the LC resonance between the leakage inductance Lp and the capacitance Cp of the plasma display panel is continued, and therefore, the voltage Vp charged in the plasma display panel falls continuously. Since the current ico is zero, the voltage Vs is maintained at the previous level of FIG. 5 (Mode 6 in FIG. 3). As described above, since a transmission path is formed as shown in FIGS. 2B, 2C, 2F and 2G, the surplus power of the driving unit 120 is transmitted to the power supply unit 110.

Referring to FIGS. 2H and 3, when the level of the voltage Vp charged in the plasma display panel becomes equal to the level of the voltage Vs charged in the stabilizing capacitor Co and has its sign reversed, the second Y electrode switch Yg and the first X electrode switch Xs are switched ON. Thus, the level of the voltage Vp charged in the plasma display panel is maintained at an equal level to the voltage Vs charged in the stabilizing capacitor Co, and its reversed sign is maintained. At this time, a voltage of (½)V_{PFC}+(Np/Ns)Vs is applied to the leakage inductance Lp to thereby linearly increase the primary-side current I_{PRI} of the transformer 113b. Since the current ico flows in a forward direction, the voltage Vs of the stabilizing capacitor Co is charged, and the surplus level of voltage Vp charged in the plasma display panel is discharged. In order to discharge the voltage Vp charged in the plasma display panel, the second switch Q_{F} is switched ON (Mode 7 in FIG. 3). The sign of the discharge current at this time is reversed with respect to that of B in FIG. 3.

Referring to FIGS. 2I and 3, in order to supply power to the plasma display panel Cp as shown in FIG. 2A, the first switch Q_{R}, the second Y electrode switch Yg and the first X electrode switch Xs are switched ON. Accordingly, a voltage of (½)V_{PFC}+(Np/Ns)Vs is applied to the leakage inductance Lp to thereby linearly increase the primary-side current I_{PRI} of the transformer 113b. At this time, the voltage Vs of the stabilizing capacitor Co is discharged, and thus the current ico flows in a reverse direction (Mode 8 in FIG. 3). Thereafter, the above-described mode operations are repetitively performed.

As described above, according to the present invention, there is no need to use a separate energy recovery circuit (ERC) absorbing surplus power supplied to a plasma display panel for use. In the present invention, an LC resonance path between the leakage inductance of the transformer and the capacitance of the plasma display panel is formed by the switching of the power conversion switch performed according to the switching of the Y electrode switch and the X electrode switch, thereby transmitting surplus power from the driving unit to the power conversion part and thus functioning as an existing energy recovery circuit (ERC). Accordingly, the circuit area and components are reduced so that slimness, a light weight and cost reductions can be achieved.

As set forth above, according to exemplary embodiments of the invention, surplus power of a plasma display panel can be absorbed by performing power conversion switching according to the switching of a sustain circuit and thus forming a transmission path using resonance between the inductance of a transformer for power conversion and the capacitance of the plasma display panel, without using an energy recovery circuit (ERC).

While the present invention has been shown and described in connection with the exemplary embodiments, it will be apparent to those skilled in the art that modifications and variations can be made without departing from the spirit and scope of the invention as defined by the appended claims.

What is claimed is:

1. A driver for a plasma display panel, the driver comprising:
a power supply unit including preset inductance, and converting alternating current (AC) commercial power into preset driving power by using the inductance; and
a driving unit switching the driving power from the power supply unit according to a logic signal and supplying the switched driving power to a plasma display panel,
wherein surplus power of the driving unit is transmitted to the power supply unit by resonance between the inductance of the power supply unit and capacitance of the plasma display panel.

2. The driver of claim 1, wherein the power supply unit comprises a power conversion part receiving and switching power to convert the power into the driving power.

3. The driver of claim 2, wherein the driving unit comprises a sustain part switching the driving power according to the logic signal and charging/discharging the plasma display panel.

4. The driver of claim 3, wherein the power conversion part performs switching according to the switching of the driving unit.

5. The driver of claim 4, wherein the power conversion part comprises:
a switching circuit performing power conversion by switching the received power according to the switching of the driving unit; and
a transformer including a primary winding receiving power from the switching circuit and a secondary winding forming a turns ratio with the primary winding, the transformer converting a voltage level of the switched power according to the turns ratio.

6. The driver of claim 5, wherein the sustain part comprises:
a pair of Y electrode switches comprising a first Y electrode switch and a second Y electrode switch connected in series to each other; and
a pair of X electrode switches connected in parallel to the pair of Y electrode switches and comprising a first X electrode switch and a second X electrode switch connected in series to each other,
wherein the first Y electrode switch is switched ON and OFF in association with the second X electrode switch,
the second Y electrode switch is switched ON and OFF in association with the first X electrode switch, alternately with the switching of the first Y electrode switch and the second X electrode switch, and
a connection point between the first and second Y electrode switches is connected to one end of the plasma display panel, and a connection point between the first and second X electrode switches is connected to the other end of the plasma display panel.

7. The driver of claim 6, wherein the switching circuit comprises first and second switches connected in series to each other between two input terminals of the received power;
wherein the first switch is switched ON when the second Y electrode switch and the first X electrode switch are switched ON,
the first Y electrode switch is switched ON alternately with the first switch, and
a connection node between the first and second switches is electrically connected to the primary winding of the transformer.

8. The driver of claim 7, wherein, when a voltage of the plasma display panel rises, a body diode of the second switch is turned ON in a dead time, which is a switching-off period of the first and second Y electrode switches and the first and second X electrode switches, and forms a transmission path for the surplus power being transmitted from the driving unit to the power conversion part, and
when the voltage of the plasma display panel falls, a body diode of the first switch is turned ON in a dead time, which is a switching-off period of the first and second Y electrode switches and the first and second X electrode switches, and forms a transmission path for the surplus power being transmitted from the driving unit to the power conversion part,
wherein the transmission path is formed by resonance between the inductance of the power supply unit and capacitance of the plasma display panel.

9. The driver of claim 8, wherein the first and second Y electrode switches and the first and second X electrode switches are switched OFF, and the first switch is switched ON and then switched OFF to turn ON the body diode of the second switch in a voltage rising period of the plasma display panel, and
the first and second Y electrode switches and the first and second X electrode switches are switched OFF, and the second switch is switched ON and then switched OFF to turn ON the body diode of the first switch in a voltage falling period of the plasma display panel.

10. The driver of claim 9, wherein the first Y electrode switch and the second X electrode switch are switched ON, the second Y electrode switch and the first X electrode switch are switched OFF and the second switch is switched ON in a maximum-voltage sustain period of the plasma display panel between the voltage rising period and the voltage falling period of the plasma display panel, and
the second Y electrode switch and the first X electrode switch are switched ON, the first Y electrode switch and the second X electrode switch are switched OFF and the first switch is switched ON in a minimum-voltage sustain period of the plasma display panel between the voltage falling period and the voltage rising period of the plasma display panel.

11. The driver of claim 2, wherein the power supply unit comprises:
a rectifying/smoothing part rectifying and smoothing the AC commercial power; and
a power factor correction part correcting a power factor of the rectified and smoothed power and supplying DC power to the power conversion part.

12. The driver of claim 8, wherein the inductance is leakage inductance of the transformer, inductance of an inductor device electrically connected in series between the primary winding and the transformer, or combined inductance of the leakage inductance of the transformer and the inductance of the inductor device.

13. A driver for a plasma display panel, the driver comprising:
a power supply unit switching alternating current (AC) commercial power and converting switched power into preset driving power; and
a driving unit switching the driving power from the power supply unit according to a logic signal and supplying the switched driving voltage to a plasma display panel,
wherein switching of the power supply unit is performed according to switching of the driving unit to thereby form a transmission path through which surplus power of the driving unit is transmitted to the power supply unit, so that the surplus power is transmitted to the power supply unit.

14. The driver of claim 13, wherein the power supply unit comprises a power conversion part switching DC power obtained by the conversion of the AC commercial power, and converting the switched DC power into the driving power having a preset voltage level, the power conversion part comprising:
a switching circuit performing power conversion by switching input power according to the switching of the driving unit; and
a transformer including a primary winding receiving power from the switching circuit and a secondary winding forming a turns ratio with the primary winding, the transformer converting a voltage level of the switched power according to the turns ratio.

15. The driver of claim 14, wherein the driving unit comprises a sustain part switching the driving power according to the logic signal and charging/discharging the plasma display panel with the driving power, the sustain part comprising:
a pair of Y electrode switches comprising a first Y electrode switch and a second Y electrode switch connected in series to each other; and
a pair of X electrode switches connected in parallel to the pair of Y electrode switches and comprising a first X electrode switch and a second X electrode switch connected in series to each other,
wherein the first Y electrode switch is switched ON and OFF in association with the second X electrode switch,
the second Y electrode switch is switched ON and OFF in association with the first X electrode switch, alternately with the switching of the first Y electrode switch and the second X electrode switch, and
a connection point between the first and second Y electrode switches is connected to one end of the plasma display panel, and a connection point between the first and second X electrode switches is connected to the other end of the plasma display panel.

16. The driver of claim 15, wherein the switching circuit comprises first and second switches connected in series to each other between two input terminals for input power,
wherein the first switch is switched ON when the second Y electrode switch and the first X electrode switch are switched ON,
the second switch is switched ON alternately with the first switch when the first Y electrode switch and the second X electrode switch are switched ON, and
a connection node between the first and second switches is electrically connected to the primary winding of the transformer.

17. The driver of claim 16, wherein, when a voltage of the plasma display panel rises, a body diode of the second switch is turned ON in a dead time, which is a switching-off period of the first and second Y electrode switches and the first and second X electrode switches, and forms a transmission path for the surplus power being transmitted from the driving unit to the power conversion part, and
when the voltage of the plasma display panel falls, a body diode of the first switch is turned ON in a dead time, which is a switching-off period of the first and second Y electrode switches and the first and second X electrode switches, and forms a transmission path for the surplus power being transmitted from the driving unit to the power conversion part,
wherein the transmission path is formed by resonance between the inductance of the power supply unit and capacitance of the plasma display panel.

18. The driver of claim 17, wherein the first and second Y electrode switches and the first and second X electrode switches are switched OFF, and the first switch is switched ON and then switched OFF to turn ON the body diode of the second switch in a voltage rising period of the plasma display panel, and
the first and second Y electrode switches and the first and second X electrode switches are switched OFF, and the second switch is switched ON and then switched OFF to turn ON the body diode of the first switch in a voltage falling period of the plasma display panel.

19. The driver of claim 18, wherein the first Y electrode switch and the second X electrode switch are switched ON, the second Y electrode switch and the first X electrode switch are switched OFF and the second switch is switched ON in a maximum-voltage sustain period of the plasma display panel between the voltage rising period and the voltage falling period of the plasma display panel, and
the second Y electrode switch and the first X electrode switch are switched ON, the first Y electrode switch and the second X electrode switch are switched OFF and the first switch is switched ON in a minimum-voltage sustain period of the plasma display panel between the voltage falling period and the voltage rising period of the plasma display panel.

20. The driver of claim 14, wherein the power supply unit comprises:
a rectifying/smoothing part rectifying and smoothing the AC commercial power; and
a power factor correction part correcting the power factor of the rectified and smoothed power and supplying DC power to the power conversion part.
